(19) United States
(12) Patent Application Publication
(10) Pub. No.: US 2003/0226794 A1
(43) Pub. Date: Dec. 11, 2003

(54) Steam boiler scale inhibitor, sludge (TSS) and TDS control, and automatic bottom blow-down management system

(76) Inventor: Alden L. Coke, Baltimore, MD (US)

Correspondence Address: ROYAL W. CRAIG, SUITE 153, 10 NORTH CALVERT STREET, BALTIMORE, MD, 21202, US

(21) Appl. No.: 10/165,213

(22) Filed: Jun. 6, 2002

(51) Int. Cl. C02F 1/48; B01D 35/06; B01D 1/00; B01D 21/30; C02F 9/00; B03C 1/02; B03C 1/30

(52) U.S. Cl. 210/222; 210/96.1; 210/143; 210/194

(57) ABSTRACT

An improved steam boiler scale inhibitor, sludge (TSS) and Total Dissolved Solids (TDS) control, and automatic bottom blow-down management system which totally eliminates the use of scale inhibitor chemicals and eliminates manual blow down for sludge control (TSS). The present system is attached by a single hookup to the mud leg or the bottom blow down port of an existing boiler. The system includes a closed-loop duct with inline circulator pump to draw water from the bottom of the boiler drum and return through the same bottom outlet port. The system includes a TDS controller connected to the circulator pump, and to both a “smart” valve and a high temperature probe exposed inside the closed loop duct. The TDS Controller is preprogrammed to time the opening, open duration and closing of the smart valve depending upon the water quality at the site location as sensed by the probe, thereby allowing for the control of TSS and TDS in the drum water. The water is also exposed to an in-line descaling tool within the system. An alternative embodiment is also shown that is better suited for boilers with pressure vessel codes requiring both fast & slow bottom blow down valves.

### BACKGROUND OF THE INVENTION

1. Field of the Invention

The present invention relates to the treatment of steam boiler water and, more particularly, to a steam boiler scale inhibitor, sludge (TSS) and Total Dissolved Solids (TDS) control, and automatic bottom blow-down management system that replaces conventional chemical treatments specified by boiler manufacturers and consulting engineering firms with mechanical treatment.

2. Description of the Background

In conventional boilers, fuel and air are mixed and injected into a combustion chamber, where the fuel is burned to produce heat. This heat is then transferred to water that is confined in a vessel and/or in tubes. Depending on the type of system, the water is distributed to its intended use as either hot water or steam. There are a variety of existing boiler water treatment mechanisms for steam boilers and hot water boilers that are designed to reduce scale build up from high temperatures that cause precipitation of minerals from the water. Such precipitation creates boiler scale which inhibits heat transfer from the tubes to the heat source and causes inefficiency of significant economic value. Corrosion is another problem, more so in steam boilers than in hot water boilers due to the oxygen that is liberated from the water. Accordingly, entrained oxygen causes a great deal of corrosion in the system and is generally controlled through oxygen scavenger chemicals or a de-aerator device mounted on the condensate return tank. A third problem associated with steam boiler water treatment is sludge (TSS) that builds up in the hot water drum when it is precipitated as a result of high temperature. This volume of precipitate is easily calculable if one knows the total dissolved solids in the feed water to the boiler, and the volume of makeup water to the boiler. This volume of precipitate is generally calculated in milligrams per liter, and over the course of time, may amount to several hundred pounds of mineral deposits which can foul a boiler drum and lead to expensive maintenance and cleaning procedures.

Unless proper maintenance procedures are continuously observed while the boilers are in operation, the resulting inefficiencies are slow to make themselves apparent and accordingly, most of the time boiler failure creeps up on the maintenance personnel

One known method to reduce precipitated boiler sludge (TSS) and scale is to control the Total Dissolved Solids (TDS), so a maximum limit can be uniformly maintained. This can be done with a TDS monitor. There are commercially available TDS monitors such as, for example, the TDS-JS5 available from Convergent Water Controls, Ltd, a leading supplier of controllers to the water treatment industry. The TDS-JS5 is a digital electronic controller with an LCD that display in either μS or TDS (selectable). The TDS-JS5 may be programmed to enter blow-down mode when the TDS is above a setpoint, or idle mode when TDS is below a setpoint. Once in blow-down mode personnel can manually activate a blow-down valve supplied with the original boiler and commence a continuous two-phase flushing flow through these valves using conventional chemical treatments specified by boiler manufacturers and consulting engineering firms. However, most existing systems rely on a top or “skimmer” blow-down process which is not as effective as a bottom-blow-down process. Conventional bottom blow-down processes are manual and very time consuming and labor intensive. Moreover, they only addresses the symptoms but not the cause. For example, in steam boilers, high stack temperature readings are evidence of scale build up due to the increased fuel required to heat the water to manufacture steam. Moreover, the chemicals that are typically used are caustics and are not environmentally safe.

Accordingly, there remains a significant need for a more comprehensive steam boiler scale inhibitor, sludge (TSS) and Total Dissolved Solids (TDS) control, and automatic blow-down management system that replaces conventional chemical treatments with mechanical treatment.

### SUMMARY OF THE INVENTION

It is, therefore, an object of the present invention to provide a steam boiler scale inhibitor, sludge (TSS) and Total Dissolved Solids (TDS) control, and automatic bottom blow-down management system that replaces conventional chemical treatments specified by boiler manufacturers and consulting engineering firms with mechanical treatment.

It is another object to provide a steam boiler management system as described above that controls & adjusts TDS levels automatically.

It is another object to provide a steam boiler management system as described above that limits corrosion with an oxygen scavenger, and that removes existing scale and prevents scale buildup.

It is yet another object to provide a steam boiler management system as described above that conserves energy by scale reduction and controlled blow down, that reduces boiler maintenance labor costs, and that reduces downtime and expensive repair jobs due to improper or careless boiler maintenance.

In accordance with the above objects, an improved steam boiler scale inhibitor, sludge (TSS) and Total Dissolved Solids (TDS) control, and automatic bottom blow-down management system is provided. The present system solves the problems and eliminates the disadvantages of prior art by providing a self-contained method and apparatus which totally eliminates the use of scale inhibitor chemicals and eliminates manual blow down for sludge control (TSS). In addition, it maintains a perfectly controlled TDS residual. The present system also offers the option of controlling corrosion through the use of an optional chemical oxygen scavenger, which may be required by some original equipment boiler manufacturers. The present system is attached by a single hookup to the mud leg or the bottom blow down port of an existing boiler. More specifically, the present system is attached by a boiler drum outlet port connector to the bottom outlet port of an existing boiler, which allows a circulator pump to draw water from the bottom of the boiler drum through the bottom outlet port and return water through the same port. The system is a closed loop system by which the water is tested and recirculated directly back into the same bottom outlet port through a smaller return tube built inside the boiler drum outlet port connector. The return tube comprises a variable length of flexible stainless steel tubing that connects to the bottom outlet port and which directs the return water away from the larger boiler drum outlet port connector to prevent a short circuit eddy pool effect.

Once the water is admitted to the system through the boiler drum outlet port connector it is exposed to an in-line descaling tool which is magnetic in nature and polarizes the minerals so they tend to not bond to the boiler drum or fire tubes in the boiler mechanism. This magnetic water conditioner does not create any pressure drop. A purge valve is also included to allow trapped air to be purged when necessary, and also to serve as a water sample cock for external sampling. An optional flow gauge monitors flow throughout the system. An essential feature of the present system is a “smart” valve connected to a programmable logic controller PLC. The PLC may be an existing TDS controller having at least one signal output to trigger an alarm, and three programmable control outputs, one of the control outputs being connected to a high temperature probe exposed inside the closed loop system. Optionally, the TDS Controller 20 may include an output port (such as RS-232C) to provide signals to a remote Building Management System (BMS) for remote monitoring. The TDS Controller is preprogrammed to time the opening, open duration and closing of the smart valve depending upon the water quality at the site location as sensed by the probe. This allows for the control of TSS and TDS in the drum water. The TDS Controller is also connected to a circulator pump which drives fluid flow through the closed loop system. The TDS Controller is preprogrammed to interrupt the circulator pump when the smart valve is opened, and to reactivate the circulator pump when the smart valve closes. The smart valve remains normally closed so that in the event of power failure it will not allow the boiler to be disabled due to low water shut off. In addition, a fail safe feature is designed into the smart valve which allows it to close fully even if power is interrupted during the blow down cycle. The TDS Controller preferably includes an output port (such as RS-232C) to provide signals to a Building Management System (BMS) for remote monitoring. The probe is flanked by two isolation valves which enable a service technician to cut-off flow to the probe to examine the probe for cleaning purposes or replacement.

The above-described system allows a simple one port hookup to control the boiler drum water cuality. It provides automatic bottom blow-down, thereby saving labor and energy while controlling scale formations. Water may be circulated through the present system 24 hours/day and returned to the drum. The system has been found to control dissolved solids constantly within 2% (3500-3430 TDS), and to automatically purge boiler drum sludge (TSS) through the programmable TDS Controller.

An alternative embodiment is also disclosed that is better suited for boilers with pressure vessel codes requiring both fast & slow bottom blow down valves. In this alternative embodiment the system can draw water from one bottom port (situated in advance of the fast & slow bottom blow down valves), and then circulate the water back to the boiler drum through a second outlet port. In this alternative embodiment the automatic blow down valve purges somewhere in between the inlet and outlet ports while allowing the required manual valving to remain fully operational.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a system diagram of a steam boiler scale inhibitor, sludge (TSS) and Total Dissolved Solids (TDS) control, and automatic bottom blow-down management system according to one embodiment of the present invention.

FIG. 2 is a system diagram of a steam boiler scale inhibitor, sludge (TSS) and Total Dissolved Solids (TDS) control, and automatic bottom blow-down management system according to an alternative embodiment of the present invention that is better suited for boilers with pressure vessel codes requiring both fast & slow bottom blow down valves.

### DETAILED DESCRIPTION OF THE PREFERRED EMBODIMENTS

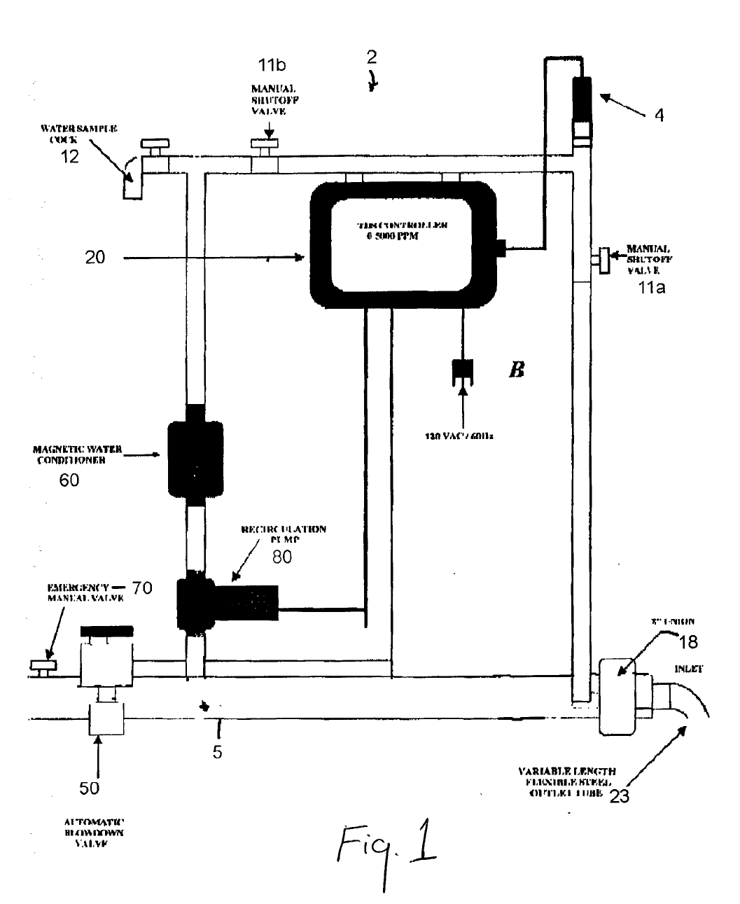

FIG. 1 is a system diagram of a steam boiler scale inhibitor, sludge (TSS) and Total Dissolved Solids (TDS) control, and automatic bottom blow-down management system 2 according to one embodiment of the present invention. The management system 2 is attached by an boiler drum bottom outlet port connector 18 to the bottom outlet port (e.g., mud leg or bottom blow down port) of an existing boiler, thereby allowing it to draw water from the bottom of the boiler drum. The boiler drum bottom outlet port connector 18 may be a standard pipe fitting. The management system 2 is itself a closed loop comprised of sections of pipe arranged in a circuit 5. The closed circuit 5 allows the water to be tested and recirculated directly back into the same bottom outlet port. However, the water is admitted back into the boiler drum bottom outlet port through a smaller return tube 23 that is built inside the boiler drum outlet port connector 18. The return tube 23 comprises a variable length of flexible stainless steel tubing that connects through the boiler drum bottom outlet port and which directs the return water away from the larger boiler drum outlet port connector 18 to prevent a short circuit eddy pool effect.

Once the water is admitted to the system through the boiler drum bottom outlet port connector 18, the water passes through recirculation pump 80 and then is directed through scaling tool 60 which is magnetic in nature and polarizes the minerals so they tend to not bond to the boiler drum or fire tubes in the boiler mechanism. A purge valve 12 is also included at the top of the circuit 5 to allow trapped air to be purged when necessary, and also to serve as a water sample cock for external sampling.

An optional flow gauge (not shown) may be provided in-line to monitor flow throughout the system.

In addition, an emergency manual shut-off valve 70 is provided adjacent the smart valve 50 for purging the circuit in case of catastrophic failure.

The smart valve 50 is electrically connected to a programmable logic controller PLC. The PLC is preferably a TDS controller 20. The TDS controller 20 is also electrically connected to a high temperature probe 4 that is exposed inside the closed loop circuit 5. The TDS Controller 20 is preprogrammed to time the opening, open duration and closing of the smart valve 50 depending upon the water quality at the site location as sensed by the probe. This allows for the control of TSS and TDS in the drum water. The TDS Controller 20 is also electrically connected to the recirculation pump 80 for automatic control of fluid flow through the closed loop circuit 5. The TDS Controller 20 is preprogrammed to interrupt the circulator pump 80 when the smart valve is opened, and to reactivate the circulator pump 80 when the smart valve closes. The smart valve remains normally closed so that in the event of power failure it will not to allow the boiler to be disabled due to low water shut off. In accordance with the present invention the smart valve 50 is a fail safe valve which fully closes even if power is interrupted during the blow down cycle. The probe 4 is flanked by two isolation valves 11a, 11b which enable a service technician to cut-off flow to the probe 4 to examine it for cleaning purposes or replacement.

In operation of the system 2, the system is powered by a 120 VAC, 10 amp electrical connection. When electrically activated, the circulator pump 80 begins circulating water through the magnetic in-line descaling tool 60 and back into the boiler drum. The process is controlled by the TDS Controller 20. The TDS Controller 20 senses when the TDS in the water gets higher than the set point and sends a signal to the automatic smart valve 50. The TDS Controller 20 is programmed to keep the automatic smart valve 50 open for a set period of time, for example, thirty seconds. The TDS Controller 20 then shuts off power to the smart valve 50 and simultaneously reactivates the circulator pump 80, bringing fresh boiler water past the probe sensor 40. After another set period of time, for example ten seconds, if the probe 40 continues to sense that the TDS is higher than the TDS set point, the cycle repeats itself. After a specified number of repetitions within a specified time (for example on the third blow down in ten minutes), the TDS Controller 20 emits an ALARM which indicates that a timing sequence change is required, or that there is a malfunction of the system, such as debris stuck in the smart valve 40. The purge valve 12 acts as an air relief valve upon start up, and also allows the operator to perform water chemistry tests on the boiler water.

The above-described system allows a simple one port hookup to control the boiler drum water cuality. It provides automatic bottom blow-down, thereby saving labor and energy while controlling scale formations. Water may be circulated through the present system 24 hours/day and returned to the drum. The system has been found to control dissolved solids constantly within 2% (3500-3430 TDS), and to automatically purge boiler drum sludge (TSS) through the programmable TDS Controller.

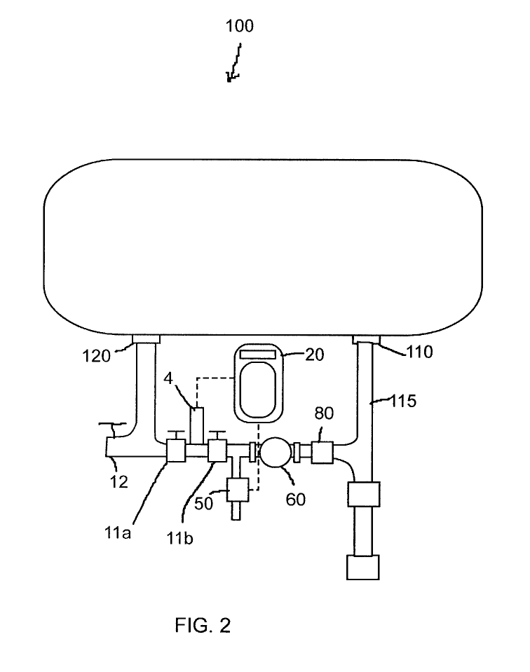

FIG. 2 is a system diagram of a steam boiler scale inhibitor, sludge (TSS) and Total Dissolved Solids (TDS) control, and automatic bottom blow-down management system 100 according to an alternative embodiment of the present invention that is better suited for boilers with pressure vessel codes requiring both fast & slow bottom blow down valves. Management system 100 is similar to the above-described embodiment 2 but adapted for a two-port connection design. This alternative embodiment 100 draws water from one bottom port 110 (situated in advance of the fast & slow bottom blow down valves), and then circulates the water back to the boiler drum through a second outlet port 120. Both of these connections may be by an boiler drum outlet port connector 18 as described above. The management system 100 is itself comprised of sections of pipe arranged in a circuit 115. The circuit 115 allows the water to be tested and recirculated directly back into the second outlet port 120

Once the water is admitted to the system through first outlet port 110, the water (at the urging of a recirculation pump 80) passes through an in-line descaling tool 60 which is magnetic in nature and polarizes the minerals so they tend to not bond to the boiler drum or fire tubes in the boiler mechanism. The recirculation pump 80 is attached to the circuit 115 by two conventional pipe unions. As before, a purge valve 12 is also included at one end of the circuit 115 to allow trapped air to be purged when necessary, and also to serve as a water sample cock for external sampling. An optional flow gauge (not shown) may be provided in-line to monitor flow throughout the system.

Again, a smart valve 50 is connected to a programmable logic controller PLC. The PLC is substantially as described above, e.g., a TDS controller 20 pre-programmed as stated. The TDS controller 20 is also connected to a high temperature probe 4 that is exposed inside the circuit 115. The TDS Controller 20 is also connected to the recirculation pump 80 for automatic control of fluid flow through the closed loop circuit 5. The smart valve 50 is again a fail safe valve which fully closes even if power is interrupted during the blow down cycle. The probe 4 is flanked by two isolation valves 11a, 11b which enable a service technician to cut-off flow to the probe 4 to examine it for cleaning purposes or replacement. Operation is as described above with reference to FIG. 1 except that water is input through one port and is output through another.

Either of the above-described embodiments of the present system solve the problems and eliminate the disadvantages of prior art by providing a self-contained method and apparatus which totally eliminates the use of scale inhibitor chemicals and eliminates manual blow down for sludge control (TSS). In addition, they maintain a perfectly controlled TDS residual. The present systems also offer the option of controlling corrosion through the use of an optional chemical oxygen scavenger, which may be required by some original equipment boiler manufacturers.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A steam boiler scale inhibitor, sludge (TSS) and Total Dissolved Solids (TDS) control, and automatic bottom blow-down management system, comprising:
a conduit attached by a boiler drum outlet port connectpr to a bottom outlet port of an existing boiler drum for drawing water from the bottom of the boiler drum, said conduit being a closed loop circuit;
a programmable logic controller (PLC);
an automatic blown down valve inline along said circuit and electrically connected to said PLC;
a recirculation pump inline along said circuit and electrically connected to said PLC for automatic control of fluid flow through the circuit;
a descaling tool inline along said circuit;
a high temperature probe inline along said circuit and electrically connected to said PLC; and
a purge valve along said circuit for purging trapped air when necessary;
said PLC being preprogrammed to time the opening, open duration and closing of the automatic blown down valve depending upon the water quality at the site location as sensed by the probe.

2. The steam boiler scale inhibitor, sludge (TSS) and Total Dissolved Solids (TDS) control, and automatic bottom blow-down management system according to claim 1, wherein said PLC comprises a TDS Controller.

3. The steam boiler scale inhibitor, sludge (TSS) and Total Dissolved Solids (TDS) control, and automatic bottom blow-down management system according to claim 2, wherein said TDS Controller is preprogrammed to interrupt the automatic blown down valve when the smart valve is opened, and to reactivate the circulator pump when the automatic blown down valve closes.

4. The steam boiler scale inhibitor, sludge (TSS) and Total Dissolved Solids (TDS) control, and automatic bottom blow-down management system according to claim 1, wherein said automatic bottom blow-down valve remains normally closed so that in the event of power failure it will not draw water from the boiler tank.

5. The steam boiler scale inhibitor, sludge (TSS) and Total Dissolved Solids (TDS) control, and automatic bottom blow-down management system according to claim 1, wherein said probe is flanked by two isolation valves inline along said circuit which enable a service technician to cut-off flow to the probe and examine it for cleaning purposes or replacement.

6. The steam boiler scale inhibitor, sludge (TSS) and Total Dissolved Solids (TDS) control, and automatic bottom blow-down management system according to claim 1, wherein water is admitted back into the bottom outlet port through a smaller return tube that is built inside the boiler drum outlet port connector, said return tube further comprising a length of flexible tubing that directs the return water away from the larger boiler drum outlet port connector to prevent eddy pool currents.

7. The steam boiler scale inhibitor, sludge (TSS) and Total Dissolved Solids (TDS) control, and automatic bottom blow-down management system according to claim 1, wherein said descaling tool further comprises an in-line magnetic water conditioner.

8. The steam boiler scale inhibitor, sludge (TSS) and Total Dissolved Solids (TDS) control, and automatic bottom blow-down management system according to claim 7, wherein said in-line magnetic water conditioner does not create any pressure differential in said circuit.

9. The steam boiler scale inhibitor, sludge (TSS) and Total Dissolved Solids (TDS) control, and automatic bottom blow-down management system according to claim 2, wherein said TDS Controller maintains TDS levels to within 2% of a contaminant value.

10. The steam boiler scale inhibitor, sludge (TSS) and Total Dissolved Solids (TDS) control, and automatic bottom blow-down management system according to claim 2, wherein said TDS Controller shuts off power to the circulator pump when said automatic blow down valve is activated.

11. The steam boiler scale inhibitor, sludge (TSS) and Total Dissolved Solids (TDS) control, and automatic bottom blow-down management system according to claim 2, wherein said TDS Controller is preprogrammed to generate an alarm in the event the automatic blow down valve is opened and closed more than a predetermined number of times in a predetermined period.

12. The steam boiler scale inhibitor, sludge (TSS) and Total Dissolved Solids (TDS) control, and automatic bottom blow-down management system according to claim 1, wherein said purge valve purges entrained gas from the circuit to limit pump cavitation.

13. The steam boiler scale inhibitor, sludge (TSS) and Total Dissolved Solids (TDS) control, and automatic bottom blow-down management system according to claim 12, wherein said purge valve doubles as a sample spigot for sample testing purposes.

14. The steam boiler scale inhibitor, sludge (TSS) and Total Dissolved Solids (TDS) control, and automatic bottom blow-down management system according to claim 1, wherein said probe is flanked by two inline isolation valves for repair, cleaning, and maintenance.
